(19) United States
(12) Patent Application Publication
(10) Pub. No.: US 2017/0045397 A1
(43) Pub. Date: Feb. 16, 2017

(54) DEVICE FOR ANALYSING A SPECIMEN AND CORRESPONDING METHOD

(71) Applicant: NATIONAL UNIVERSITY OF SINGAPORE, SINGAPORE (SG)

(72) Inventors: DANIEL SCHMIDT, Singapore (SG); SASCHA PIERRE HEUSSLER, Singapore (SG)

(73) Assignee: NATIONAL UNIVERSITY OF SINGAPORE, SINGAPORE (SG)

(21) Appl. No.: 15/302,664

(22) PCT Filed: May 7, 2015
(86) PCT No.: PCT/SG2015/050099

§ 371 Date: Oct. 7, 2016

Related U.S. Application Data
(60) Provisional application No. 61/990,174, filed on May 8, 2014.

(51) Int. Cl. G01J 3/447; G01N 21/3581; G01N 21/21

(52) U.S. Cl. CPC G01J 3/447; G01N 21/211; G01N 21/3581; G01N 2021/213; G01N 2021/3155

(57) ABSTRACT

A device for analysing a specimen is disclosed. The device comprises a first polarizer for polarizing a first beam of electromagnetic radiation; an optical device for directing the polarized beam of electromagnetic radiation at the specimen to enable interaction between the polarized beam of electromagnetic radiation and the specimen to cause generation of a second beam of electromagnetic radiation; a plurality of second polarizers for dividing the wavefront of the second beam of electromagnetic radiation into a plurality of beams of electromagnetic radiation polarized with different polarization states; and at least one spectrometer for analysing respective electromagnetic spectrums of the plurality of polarized beams of electromagnetic radiation to enable the specimen to be characterised. A related method is also disclosed.

### FIELD

The present invention relates to a device for analysing a specimen and corresponding method.

### BACKGROUND

A polarization state of a beam of electromagnetic radiation (e.g. white light) may be completely characterized by the four parameters of its Stokes vector. Typically, this may be done by carrying out repeated measurements for several discrete and appropriate orientations of a polarization state analyser (PSA), or by using a continuous periodic optical element rotation in conjunction with performing Fourier analysis of a signal detected. It is to be appreciated that a majority of modern commercial ellipsometers configured to operate in the spectral region between the vacuum ultraviolet wavelength to the infrared wavelength are rotating analyser ellipsometers fitted with an optional compensator.

Conventionally, to carry out static detection without using moving optical components, two different types of measurement instruments have been proposed that simultaneously measure all four Stokes parameters of a monochromatic light beam: the first instrument is based on the division of wavefront (DOW) principle, while the second instrument is based on the division of amplitude (DOA) principle.

In a monochromatic DOA instrument, a transmitted and a reflected light beam emerging from an amplitude dividing beam-splitter are each directed to a polarizing prism (e.g. a Wollaston prism) and then relayed to a total of four linear photodetectors. But to enable white light beams to be analysable, an enhancement to the above DOA instrument was proposed, in which the light beam exiting the polarizing prism is now guided by fiber optics into one or four grating-based multichannel spectrometers. This modification however results in a fairly bulky and expensive instrumentation and consequently has not been widely adopted. Yet a different approach to analysing white light beams based on the DOA principle is to utilize the polarization characteristics of a diffraction grating. Each diffraction order includes different information about a polarization state of an incident light. Hence, by simultaneously measuring four or more diffraction orders, an instrument may be designed to measure the wavelength-dependent full Stokes vectors.

One object of the present invention is therefore to address at least one of the problems of the prior art and/or to provide a choice that is useful in the art.

### SUMMARY

According to a 1^{st} aspect of the invention, there is provided a device for analysing a specimen, comprising: a first polarizer for polarizing a first beam of electromagnetic radiation; an optical device for directing the polarized beam of electromagnetic radiation at the specimen to enable interaction between the polarized beam of electromagnetic radiation and the specimen to cause generation of a second beam of electromagnetic radiation; a plurality of second polarizers for dividing the wavefront of the second beam of electromagnetic radiation into a plurality of beams of electromagnetic radiation polarized with different polarization states; and at least one spectrometer for analysing respective electromagnetic spectrums of the plurality of polarized beams of electromagnetic radiation to enable the specimen to be characterised.

Specifically, the second beam of electromagnetic radiation is divided into a plurality of (secondary) beams of electromagnetic radiation (e.g. four such beams) with respective polarization states, whereby the spectral distribution/composition of each polarized beam of electromagnetic radiation is then analysed by at least one spectrometer. Specifically, the polarization states and wavelength-dependent intensities of the beams of electromagnetic radiation are recorded and analysed, allowing full spectral determination of all four Stokes parameters of the second beam of electromagnetic radiation. Beneficially, the device is able to perform static data acquisition and does not use any movable optical components. Advantageously, the device enables wavelength-dependent characterization of all four components of the Stokes vector in a single measurement either in transmission or reflection mode.

Preferably, the device further may include a beam source arranged to generate the first beam of electromagnetic radiation selected from the group consisting of ultraviolet radiation, visible light, infrared radiation and Terahertz radiation.

Preferably, the beam source may be further arranged to generate the first beam of electromagnetic beam as a monochromatic beam in a single frequency or a broad band of electromagnetic radiation in multiple frequencies. To clarify, the definition of broad band here refers to broad spectrum.

Preferably, the beam source may include being arranged to direct the first beam of electromagnetic radiation at the specimen at a predetermined angle, the angle measured from the surface normal of the specimen illuminated by the first beam of electromagnetic radiation.

Preferably, the optical device may include being configured to focus or collimate the first beam of electromagnetic radiation.

Preferably, the optical device may include a lens or a mirror.

Preferably, the optical device may be arranged for collimating the first beam of electromagnetic radiation prior to the first beam of electromagnetic radiation being polarized by the first polarizer.

Preferably, the device may further comprises a processor for processing signals generated by the at least one spectrometer to obtain at least one intensity spectra for characterising the specimen.

Preferably, the at least one spectrometer may include a Fourier Transform spectrometer, a grating, a prism, a filter, or a Fabry-Perot based spectrometer.

Preferably, the device may further comprise at least a further optical device to focus or collimate the second beam of electromagnetic radiation, or the plurality of polarized beams of electromagnetic radiation.

Preferably, the further optical device may include a lens or a mirror.

Preferably, the at least one spectrometer may include a plurality of spectrometers, and a number of the plurality of spectrometers is matched to a number of the second polarizers.

Alternatively, the least one spectrometer may include a plurality of spectrometer channels, and a number of the spectrometer channels is matched to a number of the second polarizers.

Preferably, the at least one spectrometer may further include at least one detector which is arranged to detect electromagnetic radiation selected from the group consisting of ultraviolet radiation, visible light, infrared radiation and Terahertz radiation.

Preferably, the device may further comprise at least one chopper to increase a signal-to-noise ratio of the signals generated by the at least one spectrometer.

Preferably, the device may further comprise at least one beam homogenizer to increase the spatial homogeneity of the first beam of electromagnetic radiation (i.e. to minimize spatial intensity variations).

Preferably, the plurality of second polarizers may include at least three polarizers to enable the first three Stokes parameters of the second beam of electromagnetic radiation to be determined.

Preferably, the plurality of second polarizers may include at least four polarizers to enable the full Stokes vector of the second beam of electromagnetic radiation to be determined.

Preferably, the four polarizers may include three respective linear polarizers and a circular polarizer.

Preferably, the three linear polarizers and circular polarizer may respectively be arranged in polarization configurations respectively selected from the group consisting of 0°, ±45°, ±90° and ±45°±λ/4, wherein λ is a wavelength of the first beam of electromagnetic radiation and λ/4 refers to a quarter waveplate.

Preferably, the at least one detector may include a plurality of detectors, and wherein a number of the detectors is matched to a number of the second polarizers.

Preferably, the first polarizer may include a linear or circular polarizer.

Preferably, the at least one intensity spectra may include wavelength-dependent intensities.

Preferably, the second beam of electromagnetic radiation may include a beam of electromagnetic radiation reflected or transmitted from the specimen due to the interaction between the polarized beam of electromagnetic radiation and the specimen.

According to a 2^{nd} aspect of the invention, there is provided a multi-channel spectroscopic ellipsometer and polarimeter, comprising the device of the 1^{st} aspect.

According to a 3^{rd} aspect of the invention, there is provided a method of analysing a specimen by using the device of the 1^{st} aspect, the method comprises: polarizing a first beam of electromagnetic radiation using the first polarizer; directing the polarized beam of electromagnetic radiation at the specimen using the optical device to enable interaction between the polarized beam of electromagnetic radiation and the specimen to cause generation of a second beam of electromagnetic radiation; dividing the wavefront of the second beam of electromagnetic radiation using the plurality of second polarizers into a plurality of beams of electromagnetic radiation polarized with different polarization states; and analysing respective electromagnetic spectrums of the plurality of polarized beams of electromagnetic radiation using the at least one spectrometer to enable the specimen to be characterised.

According to a 4^{th} aspect of the invention, there is provided a polarization state analyser for analysing a specimen, comprising: a plurality of polarizers for dividing the wavefront of a beam of electromagnetic radiation that has interacted with the specimen into a plurality of beams of electromagnetic radiation polarized with different polarization states; and at least one spectrometer for analysing respective electromagnetic spectrums of the plurality of polarized beams of electromagnetic radiation to enable the specimen to be characterised.

It should be apparent that features relating to one aspect of the invention may also be applicable to the other aspects of the invention.

These and other aspects of the invention will be apparent from and elucidated with reference to the embodiments described hereinafter.

### BRIEF DESCRIPTION OF THE DRAWINGS

Embodiments of the invention are disclosed hereinafter with reference to the accompanying drawings, in which:

FIG. 1 depicts an exemplary schematics of a device for analysing a specimen, according to an embodiment;

FIG. 2 is a flow diagram of a method for analysing the specimen using the device of FIG. 1;

FIG. 3 depicts a data processing flow based on a parallel processing configuration of a PSA of the device of FIG. 1;

FIG. 4a is a perspective view of a prototype of the device of FIG. 1, while FIG. 4b is a top view of the prototype of FIG. 4a; and

FIG. 5 is an enlarged view of a portion of the PSA, based on the prototype of FIG. 4a.

### DETAILED DESCRIPTION OF PREFERRED EMBODIMENTS

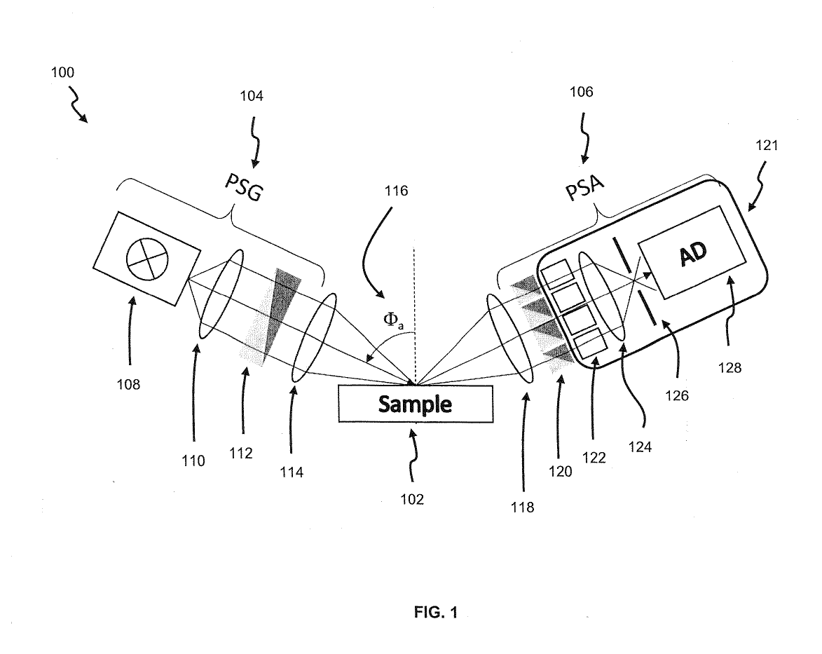

A device 100 for analysing a target specimen 102 (being investigated) is disclosed, according to an embodiment shown in FIG. 1. It is to be appreciated that the device 100 may also be known as a multi-channel spectroscopic ellipsometer and polarimeter (MC-SEP). Broadly, the device 100 has two different sections, a polarization state generator (PSG) 104, and a polarization state analyser (PSA) 106. The PSG 104 and PSA 106 may independently be mounted on a customisable goniometer or on a fixed angle base. In the PSG 104, the following components are provided and sequentially arranged in the order described: a beam source 108, a collimating lens 110, a first polarizer 112 and a first optical device 114. The beam source 108 is configured to generate a beam of electromagnetic radiation (EMR) as a measurement beam, which may be (for example) ultraviolet radiation, visible light, infrared radiation or Terahertz radiation (or any combination thereof). That is, the beam source 108 is configured to generate electromagnetic radiation with broad spectrum. In this case, for explaining this embodiment, the beam source 108 is configured to generate white light, but however not to be construed as limiting. So in this embodiment, the beam of EMR generated by the beam source will be referred to as a light beam for sake of simplicity in the discussions below. As mentioned, the device 100 works and performs similarly if the other types of EMR are used, and so for alternative embodiments, the discussed operation of the proposed device 100 below is then to read with the understanding that instances of the term “light beam” (and the associated derivative terms) are instead replaced by the associated EMR used, e.g. an ultraviolet radiation beam or a Terahertz radiation beam. The collimating lens 110 is for collimating the light beam prior to the light beam being polarized by the first polarizer 112, whereas the first polarizer 112 is for polarizing the light beam to generate a polarized light beam. The first polarizer 112 may either be a linear or circular polarizer, depending on requirements of an application intended for the device 100. The first optical device 114 directs the polarized light beam at the specimen 102 to enable interaction between the polarized light beam and the specimen 102 to generate a reflected light beam. An example of the first optical device 114 is a focusing lens.

It is also to be appreciated that the beam source 108 is suitably arranged to angularly direct the polarized light beam at the specimen 102 at a predetermined angle 116 (i.e. Fₐ), in which the angle 116 is measured from the surface normal of the specimen 102 illuminated by the light beam. The angle 116 “Fₐ” may be termed as an angle of incidence.

On the other hand, in the PSA 106, the following components are provided and sequentially arranged in the order described: a second optical device 118, a plurality of second polarizers 120, and at least one spectrometer 121. The spectrometer 121 includes a plurality of spectrometer channels 122, a third optical device 124, an optional adaptor 126 (which provides an aperture), and a detector 128. The second optical device 118 is similar in configuration to the first optical device 114, except that the second optical device 118 serves to collimate and direct the reflected light beam from the specimen 102 towards the plurality of second polarizers 120. The first and second optical devices 114, 118 are used in tandem as a pair to respectively focus the light beam onto the specimen 102 and then to collimate the reflected light beam to the PSA 106.

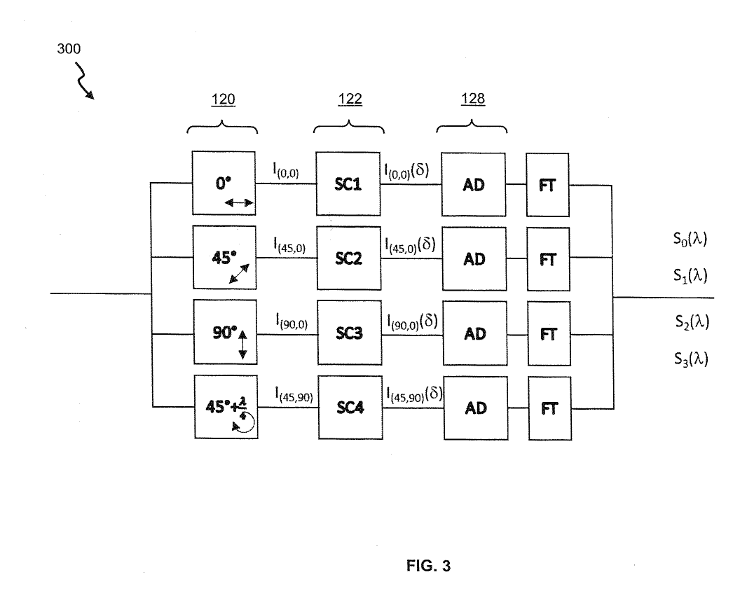

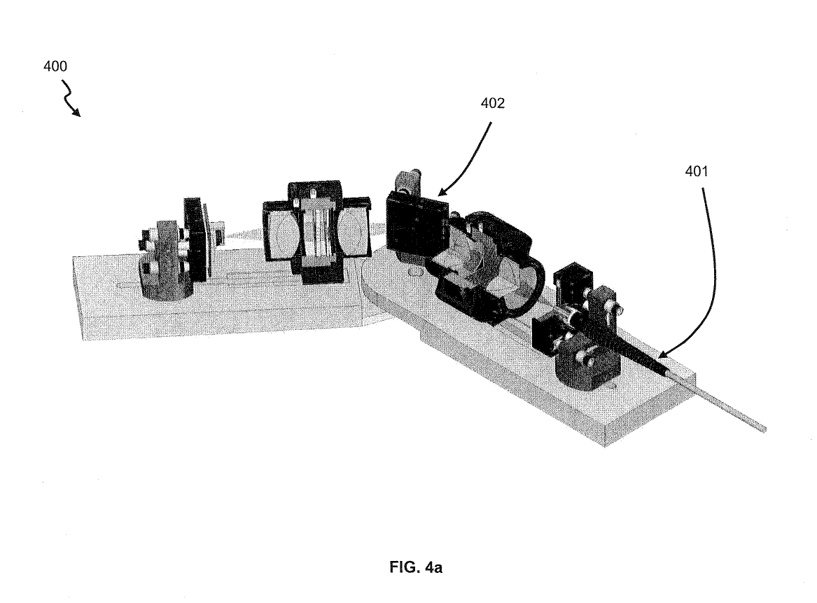

The plurality of second polarizers 120 (which provide corresponding polarizer state channels) are respectively for receiving, dividing and polarizing the wavefront of the reflected light beam into a plurality of (secondary) light beams polarized with different polarization states. In this embodiment, the plurality of second polarizers 120 includes at least four polarizers 120 to enable the full Stokes vector of the reflected light beam to be determined. Particularly, the four polarizers 120 include three linear polarizers and a circular polarizer, in which the three linear polarizers and circular polarizer are respectively configured to polarize respective (secondary) light beams at (e.g.) 0°, 45°, 90° and 45° +λ/4, wherein λ is a wavelength of the original light beam. A quarter waveplate (being included in the polarizers 120) denoted by λ/4 may be used in combination with a 45° polarizer to realise a circular polarization. This aspect will be elaborated later with respect to FIG. 3. It is to be appreciated that the circular polarizer may right or left circularly polarized the corresponding light beam thereat.

The spectrometer 121 (which provide corresponding spectrometer channels 122) is for phase-shifting and analysing the respective polarized light beams (received from the plurality of second polarizers 120) to generate phase-shifted light beams. For the analysing, the spectrometer 121 is arranged to analyse respective electromagnetic spectrums of the polarized light beams to enable the specimen to be characterised. It is to be appreciated that a number of the spectrometer channels 122 arranged in the device 100 is matched to a number of the second polarizers 120. So in this instance, at least four spectrometer channels 122 are needed, since there are at least four second polarizers 120. Each spectrometer channel 122 is (logically) paired with a corresponding second polarizer 120. The third optical device 124 is for focusing the phase-shifted light beams (output from the spectrometer channels 122) onto the optical detector 128. In this case, the third optical device 124 is a focusing lens. If the optional adaptor 126 is used, then the third optical device 124 is configured to focus the phase-shifted light beams towards the aperture provided by the adaptor 126. It is to be appreciated that the aperture is for blocking all diffraction orders other than the 0^{th} order from entering the detector 128. Following on, the detector 128 is arranged to detect the phase-shifted light beams (from the spectrometer channels 122) to enable material properties of the specimen 102 to be characterised, based on the polarization states and spectra properties of the phase-shifted light beams. In this case, the detector 128 includes a plurality of detectors (i.e. to form a detector array), although other suitable detector configurations are also not precluded from being used. An example of the detector 128 is a charge-coupled device (CCD) or any detectors which are able to detect electromagnetic radiation (e.g. ultraviolet radiation, visible light, infrared radiation or Terahertz radiation). Also, a number of the detectors arranged in the device 100 are matched to a number of the second polarizers 120. So accordingly, four detectors are utilised in the device 100, since there are at least four spectrometers 122 (for this embodiment). In other alternative embodiments, only one single detector may also be usable in the device 100.

It is to be appreciated that the first and second optical devices 114, 118 are arranged together as a pair (i.e. one cannot be used without the other in the case of focusing lenses/mirrors). Moreover, the first and second optical devices 114, 118 are optional in the device 100, depending on the measurement requirements. It is to be appreciated that improved lateral resolution is achieved with use of the first and second optical devices 114, 118.

So, the PSA 106 divides the wavefront of the reflected light beam into four (secondary) light beams with respective polarization states (e.g. three different linear and one circular polarization states), whereby the spectral distribution/composition of each polarized light beam is subsequently analysed by the associated spectrometer channel 122. This configuration allows recording of the polarization states and wavelength-dependent intensities of the light beams, allowing full spectral determination of all four Stokes parameters of the reflected light beam. It is to be appreciated that the “intensities” in the present context refer to the respective intensities of the wavelengths (of the light beams) which enable calculation of the Stokes vector components.

It is to be appreciated that a path travelled by the light beam from the light source 108 of the PSG 104 to at the detector 128 of the PSA 106 is termed as a beam path. Further, depending on a size of the specimen 102 or a size of an area of interest on the specimen 102 to be investigated using the device 100, the first optical device 114 and second optical device 118 may optionally be used to flexibly decrease a spot size of the light beam significantly to facilitate the investigation. It is to be appreciated that the described operational mode in reflection is equally valid for transmission type measurements. This means that, instead of analysing a reflected beam from the specimen 102, a beam that is transmitted through the specimen 102 is also measurable by the device 100, such as the specimen 102 being a glass sample with a thin coating (e.g. tinted windows)

The device 100 also further comprises a processor (not shown) for processing signals generated by the detector 128, in which the processor is configured to perform computations on the generated signals to obtain respective intensity spectra and for characterising the specimen 102. An example of the processor is a general computing device, such as a PC/laptop, and the processor is electrically coupled to the detector 128, either wirelessly or wired.

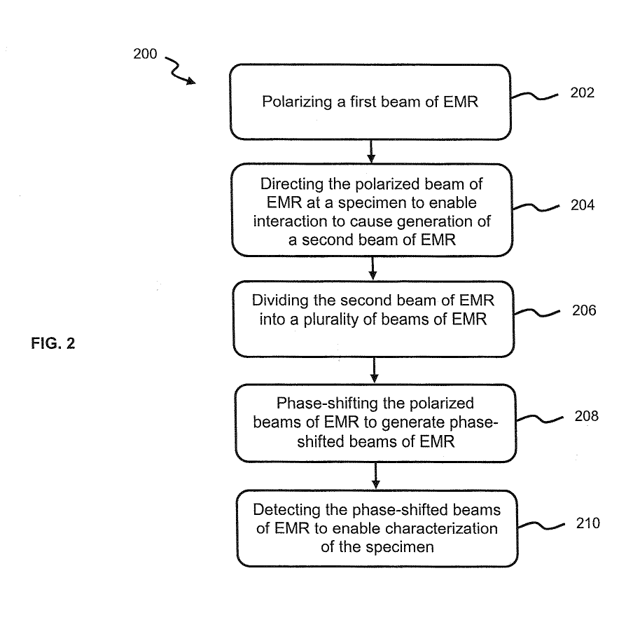

FIG. 2 is a flow diagram of a method 200 for analysing the specimen 102 using the device 100 of FIG. 1. Broadly, the method 200 comprises polarizing a first beam of EMR (e.g. a light beam) using the first polarizer 112 at step 202; directing the polarized beam of EMR at the specimen 102 using the first optical device 114 to enable interaction between the polarized beam of EMR (e.g. polarized light beam) and the specimen 102 to generate a second beam of EMR (e.g. a reflected light beam) at step 204; dividing and polarizing the wavefront of the second beam of EMR into a plurality of beams of EMR polarized with different polarization states using the respective second polarizers 120 at step 206; phase-shifting the respective polarized beams of EMR using the respective spectrometer channels 122 to generate phase-shifted beams of EMR at step 208; and detecting the phase-shifted beams of EMR using the detector 128 (at step 210) to enable the specimen 102 to be characterised, based on the polarization states and spectra properties of the phase-shifted beams of EMR.

Elaborating on the method 200, it is to be appreciated that light beam form the beam source 108 is first collimated by the collimating lens 110 and then appropriately linearly/circularly polarized by the first polarizer 112, prior to angularly illuminating the specimen 102 with the polarized light beam at the predetermined angle 116. Given the focusing and collimating pair of 114 and 118 are used, the polarized light beam is reflected from the surface of the specimen 102 to generate a reflected light beam, which are subsequently collimated by the second optical device 118 on the four second polarizers 120 (i.e. the three linear polarizers and circular polarizer) to divide and polarize the reflected light beam to provide the polarized light beams. In cases where the pair 114 and 118 is not used, the collimated beam is reflected by the specimen and is divided by the four polarizers 120 and polarized. After passing through the four second polarizers 120, the respective polarized light beams are provided to the corresponding spectrometer channels 122, which introduce phase shifts to the respective polarized light beams to generate the phase-shifted light beams, similar to a scanning mirror interferometer. It is to be appreciated that the phase-shifted light beams are output as interferograms by the corresponding spectrometer channels 122, which are then detected and imaged by the detector 128.

FIG. 3 depicts a data processing flow 300 based on a parallel processing configuration of the PSA 106 of the device 100. In particular, the reflected light beam from the specimen 102 pass through the three linear polarizers and circular polarizer, which are respectively configured to polarize the respective divided light beams (e.g.) at 0°, 45°, 90° and 45° +λ/4. The polarized light beams are subsequently transmitted through the respective four spectrometer channels 122 (i.e. labelled as SC1, SC2, SC3 and SC4 in FIG. 3) to generate the phase-shifted light beams. Particularly, each spectrometer channel 122 introduces a phase shifts of “d” to the respective polarized light beams. It is to be appreciated that this phase shifts are varying in space, which then enables spectral analysis based on a Fourier transformation operation. So, light intensities “I” of the phase-shifted light beams become a function of the introduced phase shift “d”. As above explained, the phase-shifted light beams are output as interferograms by the corresponding spectrometer channels 122, which are detected and recorded by the detector array to generate corresponding signals.

Thereafter, the processor may perform computations (e.g. Fourier transformation, matrix inversion, and/or simple algebra) on the generated signals to obtain four intensity spectra, which are in turn used to compute the four wavelength-dependent Stokes parameters Sᵢ(λ), (wherein i=0, . . . ,3) of the reflected light beam (from the specimen 102) to enable material properties of the specimen 102 to be characterised.

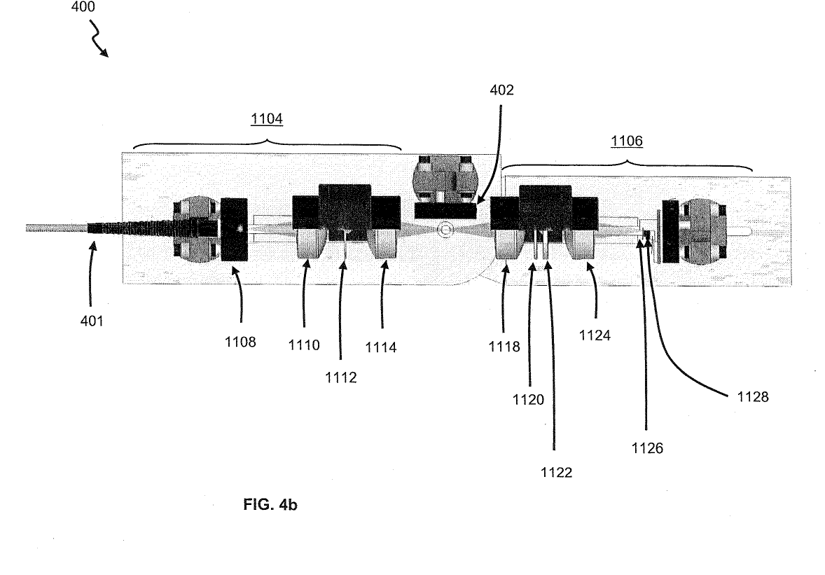

FIG. 4a is a perspective view of a prototype 400 of the device 100, while FIG. 4b is a top view of the prototype 400. It is to be appreciated that like components of the prototype 400 with those of the device 100 will be described with the same reference numerals in FIGS. 4a and 4b, but with 1000 added. For the setup of the prototype 400 shown in FIG. 4a, the angle of incidence “Fₐ” is defined to be 65° to enable focused beam measurements, while for the setup depicted in FIG. 4b, the prototype 400 is arranged in a straight through configuration (i.e. Fₐ is at 90°), which is used for calibration purposes, and for optical activity measurements in transmission (i.e. refractive) mode. Specifically, light beam from the beam source 1108 is introduced into the prototype 400 by an optical fiber 401, collimated by the collimating lens 1110, polarized by the first polarizer 1112 and then focused by the first optical device 1114 onto a specimen holder 402 (which is shown in FIGS. 4a and 4b simply for illustration purposes, and hence a specimen to be investigated is not pictured). The reflected light beam is collected by the second optical device 1118, passed through the plurality of second polarizers 1120 and associated spectrometer channels 1122 and then focused by the third optical device 1124 at an aperture of the adaptor 1126 before being detected by the detector 1128.

The disclosed prototype 400 is capable of measuring 62 wavelengths (within the ultraviolet to the near infrared spectral range), at an energy resolution of 0.025 eV. In other embodiments, a spectral range and a number of wavelengths detectable and measurable by other variant prototypes of the device 100 may depend on the type of light source, optics (e.g. lenses and polarizers), spectrometers, and optical detector used. Of noteworthy, within the visible spectral range, there are only a few measurement instances (e.g. thickness interference fringes of films thicker than 3 μm) that require spectral resolution better than 0.025 eV. Nevertheless, higher resolutions can be obtained by enlarging each individual spectrometer channel 1122 with a larger, spatially resolved phase-shifting spectrometer channel as well as increasing the overall beam diameter in the collimated beam in the prototype 400.

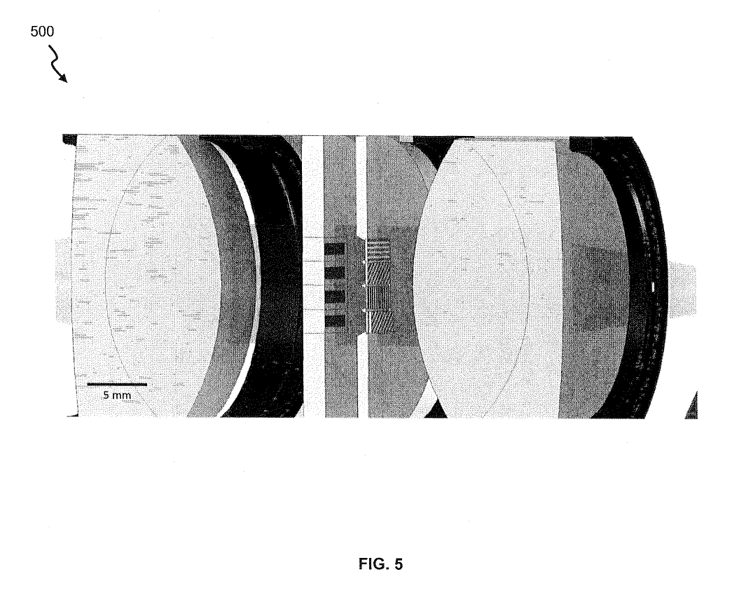

FIG. 5 is an enlarged view of a portion 500 of the PSA 1106, based on the prototype 400. FIG. 5 provides a detailed view of a combination of the plurality of second polarizers 1120 (which are arranged in a wavefront dividing configuration) and the plurality of spectrometer channels 1122 immersed in a collimated light beam with a beam diameter of about 10 mm.

For accurate detection of the divided light beams by the detector 1128, it is important that the light beams are arranged to be homogeneously illuminated over the entire surface area of the plurality of second polarizers 1120 and plurality of spectrometer channels 1122, receiving the light beams. Also, a “blind” gap of about 1 mm has been configured between adjacent spectrometer channels 1122 for sake of assembly convenience of the prototype 400 and the gap of 1 mm may be decreased substantially (if desired) to allow smaller beam sizes to be analysed. Particularly, improvements in manufacturing and assembly processes may further allow the gap to be decreased such that a maximum diameter of the divided light beams (collectively measured as a whole) illuminating the four polarizers 1120 and spectrometer channels 1122 is cumulatively less than 7 mm.

In summary, the proposed device 100 provides a compact multi-channel spectroscopic ellipsometer and polarimeter (MC-SEP) that allows wavelength-dependent characterization of all four components of the Stokes vector in a single measurement either in transmission or reflection mode. The device 100 utilises a mixture of optical components that provide refracting and/or reflecting functionalities. The device 100 is configured to operate based on the division of wavefront principle using the plurality of second polarizers 120 and the at least one spectrometer 121 (e.g. non-scanning Fourier transform spectrometers or spectrographs) to beneficially enable static data acquisition to be carried out and hence avoids usage of any movable (scanning/rotatable) optical components. Accordingly, the device 100 is realisable as a compact and portable instrument for performing wide spectral-band and ultra-fast ellipsometry/polarimetry measurements, and may also be suitable for deployment in space restricted areas.

Utilizing a non-scanning Fourier transform spectrometers, it is to be appreciated that a channel size configurable for each spectrometer channel 122 depends on a desired spectral resolution of the device 100. It may be that certain compromises have to be made to the spectral resolution so as not to exceed a desired size arrangement for the device 100, from an implementation perspective. Nonetheless, based on intended applications for the device 100, configuration of associated channels for the spectrometers 122 may be carried out as required.

Additionally, for the device 100, the spectral operating range depends largely on the optical transmission properties of the optical components used. As an example, in the disclosed embodiment, the spectral range of the device 100 extends from the ultraviolet radiation to the near infrared radiation portion of the electromagnetic spectrum. In cases where achromatic performance in the widest spectral bandwidth is required and/or e.g. infrared radiation or electromagnetic radiation beyond the visible spectral range is to be analysed, it is to be appreciated that reflection-based optical components (e.g. mirrors) may be used to replace all transmission-based optical components (e.g. lenses) in the PSG 104 as well as in the PSA 106 of the device 100. However, the functionality of each of the transmission-based optical component that is replaced by a reflection-based component remains unchanged. A reflection-based system delivers the highest signal throughput and best spectral performance. This modification does not influence the (division of wavefront) measurement principle used by the device 100 during operation, but merely modifies a design of the device 100.

It is to be highlighted that a combination of using micro-manufactured spectrometers along with adopting division of wavefront technology for the proposed device 100 opens up new opportunities/fields of applications, such as in thin film process control and optical sensing. Particularly, the proposed device 100 has the following advantages:

(1). Speed—Since only single scan measurements are needed when using the device 100, it subsequently enables determination of the full wavelength-dependent Stokes vectors in fractions of seconds (e.g. 30 fps to 1600 fps, which translate to about 0.03 seconds to 0.625 milliseconds) allowing for real-time and in-line process control.

(2). Robustness—As movable optical components are not used in the device 100, it means that the device 100 is largely immune to and unaffected by external influences (e.g. movements or vibrations) that may affect accuracy of any measurement results obtained.

(3). Compactness—The incorporation of the plurality of spectrometer channels 122 in the device 100 allows for a vastly improved design, which is small and compact and so allows the device 100 to be realised as portable (handheld) spectroscopic ellipsometers.

(4). Precision—Measurements of relative thickness of specimens may be made using the device 100 with a precision in the picometer (i.e. 10⁻¹² m) range and so optical constants may be more precisely characterized.

(5). Light throughput—The proposed device 100 makes use of the 0th diffraction order, and thus allows output of highest flux throughput (i.e. the Fellguett and Jaquinot advantage of FTIRs) compared to conventional dispersive devices (e.g. grating or prism spectrometers). It is to be appreciated that this advantage only applies in the context of cases where the spectrometer 121 is arranged in a Fourier transform spectrometer configuration.

(6). Affordability—The proposed device 100 may be manufactured at a relatively low cost (due to absence of movable optical components that may otherwise need to be positioned with extremely high precision) and thus may be priced significantly cheaper compared to conventional spectroscopic ellipsometers.

(7). Customization—Depending on requirements, the spectrometer 121 and other optical components used in the proposed device 100 may be custom configured to meet specific needs of intended applications for measurement taking in a wide spectral range.

(8). Cleanliness—Due to absence of any movable components (e.g. motors, axles and etc.) in the device 100, the device 100 consequently generates minimal debris during operation, and thus may beneficially be employed in operating environments (e.g. within a lithography tool) that require significantly high cleanliness standards. An example is application in the semiconductor industry, since the ‘finest dust’ settling on integrated circuits during manufacturing may result in defects.

As discussed, the proposed device 100 may find various applications in the industrial fields of in-line and off-line quality control of thin films. Specifically, the proposed device 100 is useful in the semiconductor (e.g. manufacturing logic, storage, light emitting diodes and etc.) and solar cell industries, as well as companies involved in the area of display and window coating. Due to the quick measurement speed afforded by the device 100, the device 100 is deployable to perform in-situ, real-time thickness and optical constant (e.g. refractive index and extinction coefficient) measurements of thin dielectric and metal films as well as multilayers. Advantageously, the device 100 may also be used in conjunction with any conventional process (vacuum) chamber for in-situ process control of thin film coatings, formed (for example) via atomic layer deposition, chemical and physical vapour deposition or spin coating. The device 100 may also be coupled to optical ports of related deposition tools in use for the coating/deposition process. The device 100 is also mountable within a process (vacuum) chamber to perform measurement taking of the thickness of thin film coatings formed, as part of the quality control.

Furthermore, by using the device 100, low cost uniformity control of large coated substrates such as solar cell, window and TV panels is advantageously performable. Typically, the substrates are often fairly bulky so that it is more practical to move a measurement tool for taking related measurements of the substrates, instead of the substrates themselves. Due to the compact arrangement and mechanical stability (owing to the lack of movable optical components) of the device 100, it is then possible to mount the device 100 (for example) on a fast moving and light-weight x-y translation stage, and map the entire surface coating of the substrates as part of the measurements taking.

Besides being useful in the above discussed commercial context, the device 100 may also find similar applications in smaller laboratories as well as in research institutes. For example, the device 100 is usage for determination of optical constants and thin film thicknesses of optically isotropic absorbing samples. Then, combined with using a rotating version of the first polarizer 112 (and possibly a retarder) in the PSG 104, anisotropic samples (e.g. nanostructures) and associated sample effects can be a subject of investigation as well.

The device 100 may also be used for determining a concentration and a purity of optically active chemicals such as steroids, antibiotics, narcotics, vitamins, sugars, and/or polymers. Conventionally, bulky bench-top instruments are used for such purposes, but the instruments are unable to take measurements for more than one wavelength. So the proposed device 100 may thus replace the bulky bench-top instruments, since the device 100 is operable in transmission mode and may also be directly deployed on production lines of the optically active chemicals.

It is known that ellipsometry is used as a technique for bio-adsorption and bio-sensing. In combination with, for example, specific bioassays, it is thus possible to use an ellipsometer to analyse blood samples and immunoassays for label-free disease detection, which means the proposed device 100 may also be used in such a scenario. Hence, it is reasonable to envisage that the device 100 may be immensely useful to general practitioners as part of their medical practice.

While the invention has been illustrated and described in detail in the drawings and foregoing description, such illustration and description are to be considered illustrative or exemplary, and not restrictive; the invention is not limited to the disclosed embodiments. Other variations to the disclosed embodiments can be understood and effected by those skilled in the art in practising the claimed invention.

For example, the beam source 108 may also be arranged to generate a monochromatic light beam by using a monochromatic source (e.g. laser) or a broad band light source in conjunction with a monochromator. Also, the device 100 may include at least one optical chopper (not shown) in the beam path to increase a signal-to-noise ratio by lock-in amplification. The optical chopper may be located in either the PSA 106 or PSG 104 (but preferably in the PSG 104). Using the optical chopper increases a signal-to-noise ratio of signals detected by the optical detector 128 and subsequently computed quantities, as well enables the device 100 to be less susceptible to ambient stray light. In addition, at least one beam homogenizer may be included in the PSG 104 to increase the spatial homogeneity of the measurement beam (i.e. to minimize spatial intensity variations). Yet further, the plurality of second polarizers 120 may alternatively include a minimum of only three (instead of four) polarizers 120 (i.e. having three appropriately polarized channels) to determine the first three Stokes parameters of the reflected light beam, from which the ellipsometric parameters LP and A may then be calculated. So, the device 100 may also be optimized to efficiently operate only with three polarizers 120 instead. Accordingly, a number of the spectrometer channels 122 (of the spectrometer 121) and the detector 128 used are to be matched to the reduced number of second polarizers 120 in this instance. Moreover, examples of the spectrometer 121 that may be used include Fourier Transform spectrometers, gratings, prisms, filters, Fabry-Perot interferometers or the like. In this instance, the third optical means 124 is to be replaced by (for example) a lens array to direct each channel into an individual spectrometer. In other words, the at least one spectrometer 121 may instead include a plurality of spectrometers (each having an associated spectrometer channel), rather than just one single spectrometer. It is to be appreciated that any type of commercially available spectrometers (or spectrographs) may be used. Hence the lens array, that focuses respective polarizers 120 to respective dedicated optical fibres, needs to be arranged after the second polarizers 120, for example. The optical fibres then guide the light beams to the respective spectrometers. Also, the device 100 (disclosed to operate in transmission mode) may be modified to allow for a substantially similar arrangement to function in a reflection mode, as per the foregoing discussions. In addition, the device 100 has a wider spectral range when operating in the reflection mode. A much wider spectral range is therefore measurable by the device 100. Optionally, the device 100 may be operated without the spectrometer 121, although it then means that only monochromatic light beams can be measured and analysed.

It is to be appreciated that suitable collimating lens of any focal length may be used in the device 100, and that the setup of the prototype 400 may be adjusted such that the angle of incidence “Fₐ” is not merely restricted to 65°. Indeed, for transmission mode operation, the device 100 may be arranged to operate with the angle of incidence “Fₐ” at 90°, whereas for reflection mode operation, the device 100 may then be arranged to operate with the angle of incidence “Fₐ”, anywhere at between about 10° to 90° . Also, a number of the spectrometer channels 122 arranged in the device 100 need not be matched to a number of the second polarizers 120; other combinations are possible. For example, it is permissible to have one spectrometer channel 122 paired to two associated polarizers 120. It is also to be appreciated that the prototype 400 may be modified to measure wavelengths of EMR from the ultraviolet to the visible to the infrared (IR) range and to the terahertz range. Moreover, the three linear polarizers and circular polarizer may also respectively be arranged in polarization configurations respectively selected from the group consisting of 0°, ±45°, ±90° and ±45°±λ/4 (e.g. 0°, 45°, −90° and 45°−λ/4, or 0°, −45°, −90° and −45°+λ/4), wherein λ is a wavelength of the original light beam beam and λ/4 denotes a quarter waveplate. In addition, it is not necessary that three linear polarizers and a circular polarizer are used; rather, any combination of a suitable number of linear polarizers and a suitable number of circular polarizers may alternatively be adopted, so long the envisaged combination enables the four Stokes vectors to be computed. Yet further, the three linear polarizers and circular polarizer may also respectively be configured to polarize the light beams in any suitable combination of positive or negative polarization (as necessary). It is to be appreciated that any suitable “photon detector” may be used as the detector 128, and the definition of “photon detector” means any detector configured to be sensitive to electromagnetic radiation of a given spectral band (e.g. ultra-violet, visible, near infrared, mid infrared, far infrared, Terahertz, or any of the foregoing combinations). Also, the PSG 104 may not include the first optical device 114, while the PSA 106 may not include the second optical device 118.

Alternatively, the PSG 104 and PSA 106 are each independently usable—for example, the PSA 106 may be adopted as a single unit by itself to be used in other similar analysers. So, the PSA 106 (configured as an independent unit) may comprise the plurality of (second) polarizers 120 for dividing the wavefront of a beam of electromagnetic radiation that has interacted with a specimen into a plurality of beams of electromagnetic radiation polarized with different polarization states; the at least one spectrometer 121 for analysing respective electromagnetic spectrums of the plurality of polarized beams of electromagnetic radiation to enable the specimen to be characterised, based on the polarization states and spectral intensities of the polarized beams of electromagnetic radiation.

Further, it is to be appreciated that the device 100 works equally well for analysing a specimen (e.g. a tinted glass) in instances where the reflected beam of EMR generated as a result of interaction between the polarized beam of EMR and the specimen is instead a beam of EMR transmitted (i.e. transmitted beam) from the specimen (to the plurality of polarizers 120) due to the interaction. So the described operation of the device 100 in respect of the reflected beam of EMR applies, mutatis mutandis, to a transmitted beam of EMR in such instances.

Also, the least one spectrometer 121 does not need to be configured on the basis of a Fourier transform spectrometer, since other suitable spectrometers may also be used for the device 100, depending on requirements of different applications intended. Accordingly, the steps 208 and 210 of FIG. 2 are then modified and the associated context of said steps instead to be understood in light of a specific type of spectrometer used

1. A device for analysing a specimen, comprising:
a first polarizer for polarizing a first beam of electromagnetic radiation;
an optical device for directing the polarized beam of electromagnetic radiation at the specimen to enable interaction between the polarized beam of electromagnetic radiation and the specimen to cause generation of a second beam of electromagnetic radiation;
a plurality of second polarizers for dividing the wavefront of the second beam of electromagnetic radiation into a plurality of beams of electromagnetic radiation polarized with different polarization states; and
at least one spectrometer for analysing respective electromagnetic spectrums of the plurality of polarized beams of electromagnetic radiation to enable the specimen to be characterised.

2. The device of claim 1, wherein the device further includes a beam source arranged to generate the first beam of electromagnetic radiation selected from the group consisting of ultraviolet radiation, visible light, infrared radiation and Terahertz radiation.

3. The device of claim 2, wherein the beam source is further arranged to generate the first beam of electromagnetic beam as a monochromatic beam in a single frequency or a broad band of electromagnetic radiation in multiple frequencies.

4. The device of claim 2, wherein the beam source includes being arranged to direct the first beam of electromagnetic radiation at the specimen at a predetermined angle, the angle measured from the surface normal of the specimen illuminated by the first beam of electromagnetic radiation.

5. The device of claim 1, wherein the optical device includes being configured to focus or collimate the first beam of electromagnetic radiation.

6. (canceled)

7. The device of claim 5, wherein the optical device is arranged for collimating the first beam of electromagnetic radiation prior to the first beam of electromagnetic radiation being polarized by the first polarizer.

8. The device of claim 1, further comprising a processor for processing signals generated by the at least one spectrometer to obtain at least one intensity spectra for characterising the specimen.

9. (canceled)

10. The device of claim 1, further comprising at least a further optical device to focus or collimate the second beam of electromagnetic radiation, or the plurality of polarized beams of electromagnetic radiation.

11. (canceled)

12. The device of claim 1, wherein the at least one spectrometer includes a plurality of spectrometers, and a number of the plurality of spectrometers is matched to a number of the second polarizers.

13. The device of claim 1, wherein the least one spectrometer includes a plurality of spectrometer channels, and a number of the spectrometer channels is matched to a number of the second polarizers.

14. The device of claim 1, wherein the at least one spectrometer further includes at least one detector which is arranged to detect electromagnetic radiation selected from the group consisting of ultraviolet radiation, visible light, infrared radiation and Terahertz radiation.

15. The device of claim 8, further comprising at least one chopper to increase a signal-to-noise ratio of the signals generated by the at least one spectrometer.

16. The device of claim 1, wherein the plurality of second polarizers include at least three polarizers to enable the first three Stokes parameters of the second beam of electromagnetic radiation to be determined.

17. The device of claim 1, wherein the plurality of second polarizers include at least four polarizers to enable the full Stokes vector of the second beam of electromagnetic radiation to be determined.

18. The device of claim 17, wherein the four polarizers include three respective linear polarizers and a circular polarizer.

19. The device of claim 18, wherein the three linear polarizers and circular polarizer are respectively arranged in polarization configurations respectively selected from the group consisting of 0°, ±45°, ±90° and ±45°±λ/4, wherein λ is a wavelength of the first beam of electromagnetic radiation.

20. The device of claim 14, wherein the at least one detector includes a plurality of detectors, and wherein a number of the detectors is matched to a number of the second polarizers.

21-23. (canceled)

24. The device of claim 1, further comprising at least one beam homogenizer to increase the spatial homogeneity of the first beam of electromagnetic radiation.

25. (canceled)

26. A method of analysing a specimen by using the device of claim 1, the method comprises:
polarizing a first beam of electromagnetic radiation using the first polarizer;
directing the polarized beam of electromagnetic radiation at the specimen using the optical device to enable interaction between the polarized beam of electromagnetic radiation and the specimen to cause generation of a second beam of electromagnetic radiation;
dividing the wavefront of the second beam of electromagnetic radiation using the plurality of second polarizers into a plurality of beams of electromagnetic radiation polarized with different polarization states; and
analysing respective electromagnetic spectrums of the plurality of polarized beams of electromagnetic radiation using the at least one spectrometer to enable the specimen to be characterised.

27. A polarization state analyser for analysing a specimen, comprising:
a plurality of polarizers for dividing the wavefront of a beam of electromagnetic radiation that has interacted with the specimen into a plurality of beams of electromagnetic radiation polarized with different polarization states; and
at least one spectrometer for analysing respective electromagnetic spectrums of the plurality of polarized beams of electromagnetic radiation to enable the specimen to be characterised.
